(19) United States
(12) Patent Application Publication
(10) Pub. No.: US 2022/0073429 A1
(43) Pub. Date: Mar. 10, 2022

(54) MODIFIED ASPHALT COMPOSITION

(71) Applicant: ARLANXEO CANADA INC., Ontario (CA)

(72) Inventors: Kevin KULBABA, Ontario (CA); Judy DOUGLAS, Oakdale, PA (US)

(73) Assignee: ARLANXEO CANADA INC., Ontario (CA)

(21) Appl. No.: 17/416,674

(22) PCT Filed: Dec. 19, 2019
(86) PCT No.: PCT/CA2019/051856

§ 371 Date: Jun. 21, 2021

(30) Foreign Application Priority Data
Dec. 21, 2018 (EP) 18215137.3

(51) Int. Cl. C04B 26/26; E01C 7/26; C04B 24/26; C04B 22/02

(52) U.S. Cl. CPC C04B 26/26; E01C 7/265; C04B 2111/0075; C04B 24/2611; C04B 22/02; C04B 24/2676

(57) ABSTRACT

A modified asphalt composition contains a bituminous component, a copolymeric thermoplastic elastomer (TPE), a high-cis homopolymeric polybutadiene rubber (BR) and a cross-linking agent. The modified asphalt composition exhibits improved low temperature flexibility (crack resistance), improved resistance to rutting (deformation) and/or improved storage stability.

### FIELD

This application relates to asphalt compositions, in particular to polymer modified asphalt compositions and processes for producing polymer modified asphalt compositions.

### BACKGROUND

The addition of various polymers to bitumen has led to asphalt compositions having improved low temperature flexibility (crack resistance) as well as improved high temperature properties to resist rutting (deformation) of the asphalt composition during long term use.

Modification of bitumen is accomplished in a vast majority of cases by the use of thermoplastic elastomers (especially the triblock copolymer styrene-butadiene-styrene (SBS)) or by the use of various polar group functionalized polymers or additives in order to be compatible with the asphalt structure. While SBS is more compatible with bitumen (i.e. will not readily demix from the bitumen over time), non-polar elastomers (e.g. polybutadiene) can phase separate (i.e. demix) readily over time from a highly aromatic bitumen making the use of non-polar elastomers impractical as the mixture will become unstable and phase separate during transport and application. Known polymer modified asphalt compositions suffer from high cost, poor aging resistance and lower than desired storage stability. (Zhu, J., Birgisson, B., Kringos, N. (2014) Polymer modification of bitumen: Advances and challenges. European Polymer Journal, 54: 18-38.)

U.S. Pat. No. 5,190,998 describes the use of polybutadiene (with high vinyl content) in asphalt modification, which leads to a material that is free of sulfur or peroxide with an elastic recovery of more than 50%. Examples of polybutadiene-modified asphalt show some improved penetration results, but the mixtures do not meet requirements for ductility recovery for roadwork applications. There is no disclosure of an asphalt product in which a blend of polybutadiene rubber and a thermoplastic elastomer is utilized.

United States Patent Publication US 2006/0223915 describes an asphalt (bitumen) composition which includes an elastomeric component and a specific crosslinking mixture, which is inherently better than sulfur and which avoids the generation of hydrogen sulfide. There is no disclosure of an asphalt product in which a blend of polybutadiene rubber and a thermoplastic elastomer is utilized.

U.S. Pat. No. 6,348,525 describes a copolymer of a substituted aromatic polymer (SBR or SBS block copolymers) with sulfur for improved storage stability, which can be applied to both asphalt emulsions as well hot melt asphalts. There is no disclosure of an asphalt product in which a blend of polybutadiene rubber and a thermoplastic elastomer is utilized.

A. Fawcett et al: “Polystyrene and asphaltene micelles within blends with a bitumen of an SBS block copolymer and styrene and butadiene homopolymers”, Colloid & Polymer Science, vol 281, no. 3, 1 Mar. 2003, pages 203-213, describes blends of the bitumen with a styrene-butadiene-styrene (SBS) block copolymer and with blends of the bitumen with SBS and one or two homopolymers, a polystyrene and a poly(cis-butadiene). However, a cross-linker is not disclosed.

EP 3 018 171 A1 describes an asphalt modifying agent and an asphalt composition containing the same. More specifically, disclosed are an asphalt modifying agent comprising a vinyl aromatic hydrocarbon-conjugated diene block copolymer and a low-molecular weight conjugated diene rubber (LCDR), and an asphalt composition containing the same. However, an asphalt composition having high-cis polybutadiene is not disclosed.

KR 2011 0038244 A describes that a vinyl aromatic hydrocarbon-conjugated diene block copolymer composition is provided to reduce a low temperature flection temperature while maintaining little reduction of a softening point temperature and viscosity and to improve low temperature properties of asphalt. In detail, it is described that a vinyl aromatic hydrocarbon-conjugated diene block copolymer composition includes: a vinyl aromatic hydrocarbon-conjugated diene block copolymer; and an unsaturated homopolymer or copolymer with number average molecular weight of 500-10,000 g/mol, wherein the unsaturated homopolymer or copolymer is polymerized with one kind of the unsaturated hydrocarbon monomer having C4-5 double bond and is copolymerized with different two kinds of unsaturated monomer. However, an asphalt composition having high-cis polybutadiene is not disclosed.

There remains a need for polymer modified asphalt compositions with lower amounts of expensive polymeric component while retaining or improving one or more of low temperature flexibility (crack resistance), resistance to rutting (deformation), aging resistance and/or storage stability, especially for polymer modified asphalt compositions that can be modified in view of the chemical composition of the asphalt to achieve such superior performance and compatibility.

### SUMMARY

In one aspect, there is provided a modified asphalt composition comprising: a bituminous component; a copolymeric thermoplastic elastomer (TPE); a homopolymeric polybutadiene rubber (BR); and, a cross-linking agent.

In another aspect, there is provided a process for producing a modified asphalt composition comprising mixing a mixture of a copolymeric thermoplastic elastomer (TPE), a homopolymeric polybutadiene rubber (BR) and a cross-linking agent with a bituminous component to form the modified asphalt composition.

The modified asphalt composition exhibits improved low temperature flexibility (crack resistance), improved resistance to rutting (deformation) and/or improved storage stability.

The modified asphalt composition may be used, for example, in road construction and repair, adhesives, sealants, water proofing membranes, weather proofing applications, roofing applications and the like. In one embodiment, the modified asphalt composition may be used as a binder in road construction and repair. In another embodiment, the modified asphalt composition may be used as an adhesive for shingles or for backing layers for other roofing products.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### DETAILED DESCRIPTION

A blend of copolymeric thermoplastic elastomer (TPE) and high-cis homopolymeric polybutadiene rubber (BR) has now been found to offer a cost-effective solution to polymer modified asphalt. A reduced amount of TPE can be used in conjunction with BR and a cross-linking agent (especially sulfur) at the same total weight loading of polymer as a higher loading of the TPE alone to obtain the same or better dynamic and physical properties without changing the weight loading of polymer in the modified asphalt composition. Thus, a lower amount of TPE can be used in conjunction with BR to achieve a modified asphalt composition with good low temperature flexibility, good high temperature elasticity and good mix stability according to standardized testing for modified asphalt products. Additionally, the ability to replace some of the TPE with BR provides for more easily processed asphalt compositions.

Further, using high cis homopolymeric BR provides comparable results in terms of storage stability and further shows higher values of penetration. With this regard, higher values of penetration may be advantageous, such grades are used in colder regions to prevent the occurrence of excessive brittleness. High penetration grade is for example used in spray application works.

The BR and TPE are preferably present in a weight ratio of BR to TPE of about 10:1 to about 1:10, more preferably about 5:1 to about 1:1. In one embodiment, the weight ratio of BR to TPE may be about 3:1 to about 1:1. Preferably, the total amount of TPE and BR together is about 25 wt % or less, based on total weight of the modified asphalt composition, more preferably about 20 wt % or less. In some embodiments, the total amount of TPE and BR together may be about 6 wt % or less, or even about 3 wt % or less. The total amount of TPE and BR together is preferably about 1 wt % or more.

The copolymeric thermoplastic elastomer (TPE) may be one or more copolymeric thermoplastic elastomer useful in a polymer modified asphalt composition. Some preferred examples of copolymeric thermoplastic elastomers include styrene-butadiene-styrene (SBS) copolymer, styrene-isoprene-styrene (SIS) copolymer, styrene-ethylene/butylene/styrene (SEBS) copolymer, styrene-butadiene-ethylene/butylene-styrene (SBEBS) copolymer, styrene-butadiene (SB) copolymer, styrene-butadiene rubber (SBR) and ethylene propylene diene monomer rubber (EPDM). The TPE may be linear, branched, radial or star-shaped. The TPE preferably has a molecular weight of about 500,000 Da or less, or about 350,000 or less. The TPE preferably has a molecular weight of about 50,000 Da or more, or about 70,000 Da or more. The molecular weight may be in a range of about 70,000 Da to about 350,000 Da. The TPE is preferably present in the composition in a range of about 0.5-10 wt %, based on total weight of the modified asphalt composition. In a particularly preferred embodiment, the TPE is present in a range of about 1-5 wt %, or about 1-3 wt %, for example about 1 wt %.

Styrene-butadiene-styrene (SBS) triblock copolymer is particularly preferred as its use in the present composition together with the homopolymeric polybutadiene rubber leads to a particularly improved combination of storage stability, resistance to rutting and resistance to low temperature cracking at lower cost. The SBS may be linear, branched, radial or star-shaped, preferably linear. SBS copolymers may be composed of styrene-butadiene-styrene triblock chains with a biphasic morphology of rigid polystyrene (PS) domains (dispersed phase) in a flexible polybutadiene (PB) matrix (continuous phase).

The homopolymeric polybutadiene rubber (BR) is a synthetic rubber formed from the polymerization of 1,3-butadiene monomer. Polybutadiene rubbers may be linear or branched, for example star branched. Suitable grades of polybutadiene rubbers include high and low cis polybutadienes, high and low trans polybutadienes and high vinyl polybutadienes. Polybutadiene rubber grades may be produced by suitable choice of polymerization catalyst. Catalysts include, for example, Ziegler-Natta catalysts based on transition metals (e.g. cobalt, nickel, titanium, lanthanum and neodymium) and organolithium compounds (e.g. alkyllithium compounds). In particularly preferred embodiments, the use of polybutadiene rubber grades formed from neodymium or lithium catalysts provide for modified asphalt compositions that meet or exceed industry standards for road work applications. According to the present invention, high-cis polybutadienes are used.

High cis polybutadienes, according to general technical knowledge and according to the present invention shall particularly mean polybutadiene which has a cis content of >93%, preferably >95%.

The viscosity and molecular weight of the homopolymeric polybutadiene rubber may be important for storage stability of the modified asphalt composition. Preferably, the BR has a Mooney viscosity of about 41 (ML 1+4 @ 100° C.) or greater, more preferably 44 or greater. The viscosity of the BR is preferably not too high, which may be detrimental to processing. In a preferred embodiment, the BR has a Mooney viscosity in a range of about 44-90 (ML 1+4 @ 100° C.), more preferably 44-70. Preferably, the BR has a molecular weight in a range of about 50,000-500,000 Da, for example about 70,000-350,000 Da.

The cross-linking agent may be present in an amount of about 1-10 wt % on an active basis, based on weight of TPE and BR in the modified asphalt composition. The cross-linking agent may be advantageously present in the composition in a relatively low amount, for example in an amount in a range of about 0.05-1 wt %, based on total weight of the modified asphalt composition. The cross-linking agent may be present in an even lower amount than 1 wt %, for example less than about 0.2 wt %. In one embodiment, the cross-linking agent is present in an amount of about 0.1 wt %. The cross-linking agent may comprise, for example, elemental sulfur, phenol-aldehyde resins (Butaphalt™), sulfur donors, sulfur accelerator or mixtures thereof. The cross-linking agent is preferably elemental sulfur, which has been found to provide greater storage stability to the composition preventing the thermoplastic copolymer and homopolymeric polybutadiene rubber from demixing from the bituminous component over a longer length of time.

The bituminous component present in the modified asphalt composition may be, for example, bitumen (naturally occurring bitumen), a material derived from a mineral oil, a petroleum pitch obtained by a cracking process, a coal tar or any blend thereof. Some examples of suitable components include distillation or “straight-run bitumens”, precipitation bitumens, e.g. propane bitumens, blown bitumens, e.g. catalytically blown bitumen or “Multiphate”, and mixtures thereof. Other suitable bituminous components include mixtures of one or more of these bitumens with extenders (fluxes) such as petroleum extracts, e.g. aromatic extracts, distillates or residues, or with oils. Suitable bituminous components are generally known in the art. The bituminous component makes up the balance of the modified asphalt composition after factoring all other components.

The modified asphalt composition may also, optionally, contain other ingredients that may be required for the end use. Other ingredients may include, for example, one or more of fillers (e.g. talc, calcium carbonate, carbon black and the like), solvents, resins, oils, fluxes, stabilizers, antioxidants, flame retardants, anti-slip additives (e.g. amines, polyamines and the like), pigments and recycled materials (e.g. tire crumb rubber, recycled asphalt shingles, recycled asphalt pavement and the like). The content of other ingredients may be in the range of from about 0 to about 40% by weight, based on total weight of the modified asphalt composition.

In a particularly preferred embodiment, the modified asphalt composition comprises: bitumen; about 1-5 wt % of styrene-butadiene-styrene (SBS) triblock copolymer and homopolymeric polybutadiene rubber (BR) combined; and, about 0.05-0.2 wt % sulfur, all weights based on total weight of the modified asphalt composition.

The modified asphalt composition may be prepared by mixing all of the components together in a suitable mixer, either in a batch or a continuous process. Preferably, the copolymeric thermoplastic elastomer (TPE), homopolymeric polybutadiene rubber (BR) and cross-linking agent are mixed to form a polymer/cross-linker mixture followed by dispersing the polymer/cross-linker mixture in the bituminous component to form the modified asphalt composition. More preferably, a polymer blend is first formed by blending the copolymeric thermoplastic elastomer with the homopolymeric polybutadiene rubber, and then the cross-linking agent is blended into the polymer blend to form the polymer/cross-linker mixture before mixing the polymer/cross-linker mixture with the bituminous component. In one embodiment, the copolymeric thermoplastic elastomer with the homopolymeric polybutadiene rubber are wetted in a tank, and then transferred to a colloid mill to be mixed with the bituminous component. Mixing is preferably done at a temperature in a range of about 150-200° C., more preferably about 160-190° C., for several hours, depending on concentration and molecular weight of the polymers. Radial configurations of high molecular weight require longer mixing times.

### Examples

### Thermoplastic Elastomer Copolymers:

Dyansol™ C-501 (linear triblock SBS, 31% styrene)

Arlanxeo™ Buna BL30-4548 (diblock SB, 48% styrene (30% in block form))

### Polybutadiene Rubbers:

Arlanxeo™ Buna CB60 (Li, medium cis, star-shaped, Mooney 1+4@100° C.=60)

Arlanxeo™ Buna CB24 (Nd, high cis 1:4 PB, Mooney 1+4@100° C.=44)

Arlanxeo™ Buna CB45 (Li, medium cis, Mooney 1+4@100° C.=45)

Arlanxeo™ Buna CB1220 (Co, high cis 1:4 PB, Mooney 1+4@100° C.=40)

Arlanxeo™ Buna CB1221 (Co, high cis 1:4 PB, Mooney 1+4@100° C.=53)

Arlanxeo™ Buna CB1203 (Co, high cis 1:4 PB, Mooney 1+4@100° C.=43)

### Asphalt (Bitumen):

AC-5 (52-22) and AC-5 (52-28) samples from Marathon Petroleum.

### Elemental Sulfur (S):

100% purity finely ground elemental Sulfur from Fisher Science Education.

### Mixing Procedure:

Modified asphalt composition samples were prepared by mixing the Asphalt, and Polymers for 2-4 hours at 350-380° F. (177-193° C.) using a Ross high shear disperser. For samples including Sulfur, the Polymers and Sulfur were first blended before blending the resulting polymer blend with the Asphalt. The sulfur is added only after the polymer has been successfully dispersed in the asphalt. Sulfur is only added to the polymer in the case of dispersed products such as SBR Latex. It is desirable to fully associate the polymer with the asphalt prior to initiating cross linking with the sulfur.

### Testing Asphalt Alone:

For comparison, performance of the base Asphalt (3 different batches) were tested using standard test procedures AASHTO T313 and AASHTO T315. The results are provided in Table 1.

TABLE 1

| | AC-5 | AC-5 | AC-5 |
|---|---|---|---|
| | (SOP) | (SOP) | (SOP) |
| Test | Batch 1 | Batch 2 | Batch 3 |
| Original Dynamic Shear (G*/sinδ, 10 rad/sec) | 1.998 | 1.859 | 1.377 |
| per AASHTO T315, kPa, 52° C. | | | |
| Original Dynamic Shear (G*/sinδ, 10 rad/sec) | 1.992 | 1.853 | 1.373 |
| per AASHTO T315, kPa, 52° C. | | | |
| Original Dynamic Shear (Phase Angle °) per | 85.67° | 85.37° | 85.78° |
| AASHTO T315, °, 52° C. | | | |
| Post RTFO Dynamic Shear (G*/sinδ, 10 | 6.062 | 5.525 | 4.207 |
| rad/sec) per AASHTO T315, kPa, 52° C. | | | |
| Post RTFO Dynamic Shear (G*/sinδ, 10 | 5.976 | 5.437 | 4.146 |
| rad/sec) per AASHTO T315, kPa, 52° C. | | | |
| Post RTFO Dynamic Shear (Phase Angle °) | 80.35° | 79.75° | 80.23° |
| per AASHTO T315, °, 52° C. | | | |
| Post Pressure Aging Vessel Dynamic Shear, | 3,051 | 2,916 | 2,323 |
| (G*sinδ, 10 rad/sec) per AASHTO T315, kPa, | | | |
| 19° C. | | | |
| Post Pressure Aging Vessel Dynamic Shear, | 4,779 | 4,728 | 3,963 |
| (G*) per AASHTO T315, kPa, 19° C. | | | |
| Post Pressure Aging Vessel Dynamic Shear, | 39.68° | 38.08° | 35.88° |
| (Phase Angle °) per AASHTO T315, °, 19° C. | | | |
| Creep Stiffness, Stiffness @ 60 sec, per | 78.6 | 80.3 | 54.9 |
| AASHTO T313, MPa, −12° C. | | | |
| Creep Stiffness, m-value @ 60 sec per | 0.334 | 0.323 | 0.346 |
| AASHTO T313, −12° C. | | | |
| PG | 52-22 | 52-22 | 52-28 |

Note:
The three different base asphalts were then graded based on the measured results and found to be AC (52-22) for Batches 1 and 2 and AC-5 (52-28) for Batch 3. It is common that some variation exists in base asphalt depending on the source and processing conditions in the refiner. When modifying asphalt, it is important to compare the changes according to the base asphalt. Jumping of 1 or 2 PG grades is a significant change with polymer modification.

### Testing Modified Asphalts for Stability (Phase Separation):

Modified asphalts were prepared by the mixing procedure described above. The asphalt used in examples 1-14 was the AC-5 Batch 1, in examples 15-20 was the AC-5 Batch 2, and examples 21-26 was the AC-5 Batch 3, with properties listed in Table 1. The total loading of polymeric components in all samples was set from 0 to 3 wt %, based on total weight of the modified asphalt. Up to 3 wt % is most common in the industry, and higher polymer loadings are also possible.

The stabilities of the modified asphalts without sulfur and with 0.1 wt % sulfur were tested. The results without sulfur are shown in Table 2, and the results with 0.1 wt % sulfur are shown in Tables 3-5. Comparative examples that were tested include unmodified asphalt (AC-5 (52-22)) (Ex. 1 and Ex. 8), asphalt modified with one copolymer (3 wt % SBS; Ex. 2 and Ex. 9), and asphalt modified with two copolymers (1 wt % SBS and 2 wt % SB; Ex. 3 and Ex. 10). Tables 2 and 3 use AC-5(5-22) being of batch 1, table 4 uses AC-5(5-22) being of batch 2 and table 5 uses AC-5(5-22) being of batch 3, so different batches having slightly different properties are used in tables 1 to 5.

Softening point separation is measured to determine if the polymer is staying mixed with the asphalt, and is therefore a measure of storage stability. Thus, the separation temperature is the difference in temperature from the softening point, which will change if the polymeric components separate from the asphalt. The softening point separation test involves adding 50 grams±0.5 grams of modified asphalt to a 32 mm diameter by 160 mm long aluminum tube closed at one end. The tube is then placed vertically in an oven for 48 hours at 163° C. after which it is removed and cooled rapidly with the top and bottom third segments (about 5 cm each) isolated for testing. The softening point of these segments are measured and reported. To meet industry requirements, the separation temperature should be no more than about 3.6° F. Softening point is measured by creating a membrane of the polymer modified asphalt within a loop and placing a 3.5 gram steel ball on top of the membrane. The temperature at which the ball falls through the membrane is the measured softening point.

The penetration test was done at ambient conditions (75-80° F.), and reflects the hardness of the material.

TABLE 2

| | Ex. 1 | Ex. 2 | Ex. 3 | Ex. 4 | Ex. 5 | Ex. 6 | Ex. 7 |
|---|---|---|---|---|---|---|---|
| AC-5 (52-22) | 100 | 97 | 97 | 97 | 97 | 97 | 97 |
| (wt %) | | | | | | | |
| C-501 | 0 | 3 | 1 | 1 | 1 | 1 | 1 |
| (wt %) | | | | | | | |
| BL 30-4548 | 0 | 0 | 2 | 0 | 0 | 0 | 0 |
| (wt %) | | | | | | | |
| CB45 | 0 | 0 | 0 | 2 | 0 | 0 | 0 |
| (wt %) | | | | | | | |
| CB1220 | 0 | 0 | 0 | 0 | 2 | 0 | 0 |
| (wt %) | | | | | | | |
| CB24 | 0 | 0 | 0 | 0 | 0 | 2 | 0 |
| (wt %) | | | | | | | |
| CB60 | 0 | 0 | 0 | 0 | 0 | 0 | 2 |
| (wt %) | | | | | | | |
| S | 0 | 0 | 0 | 0 | 0 | 0 | 0 |
| (wt %) | | | | | | | |
| Penetration | 149 | 98 | 107 | 110 | 110 | 124 | 115 |
| (dmm) | | | | | | | |
| Softening | 99.4 | 128.8 | 128.2 | 126.1 | 128.5 | 126.7 | 125.1 |
| Point (° F.) | | | | | | | |
| Separation | 0 | 1 | 15.8 | 5.1 | 9.1 | 13.3 | 13.4 |
| (° F.) | | | | | | | |
| Viscosity #21 | 215 | 465 | 685 | 750 | 673 | 738 | 600 |
| @ 280° F. (cPs) | | | | | | | |
| Viscosity #21 | 80 | 173 | 260 | 265 | 233 | 245 | 200 |
| @ 335° F. (cPs) | | | | | | | |
| Viscosity #21 | 58 | 95 | 153 | 157 | 138 | 143 | 113 |
| @ 375° F. (cPs) | | | | | | | |

TABLE 3

| | Ex. 8 | Ex. 9 | Ex. 10 | Ex. 11 | Ex. 12 | Ex. 13 | Ex. 14 |
|---|---|---|---|---|---|---|---|
| AC-5 (52-22) | 100 | 96.9 | 96.9 | 96.9 | 96.9 | 96.9 | 96.9 |
| (wt %) | | | | | | | |
| C-501 | 0 | 3 | 1 | 1 | 1 | 1 | 1 |
| (wt %) | | | | | | | |
| BL 30-4548 | 0 | 0 | 2 | 0 | 0 | 0 | 0 |
| (wt %) | | | | | | | |
| CB45 | 0 | 0 | 0 | 2 | 0 | 0 | 0 |
| (wt %) | | | | | | | |
| CB1220 | 0 | 0 | 0 | 0 | 2 | 0 | 0 |
| (wt %) | | | | | | | |
| CB24 | 0 | 0 | 0 | 0 | 0 | 2 | 0 |
| (wt %) | | | | | | | |
| CB60 | 0 | 0 | 0 | 0 | 0 | 0 | 2 |
| (wt %) | | | | | | | |
| S | 0 | 0.1 | 0.1 | 0.1 | 0.1 | 0.1 | 0.1 |
| (wt %) | | | | | | | |
| Penetration | 175 | 106 | 117 | 105 | 115 | 113 | 111 |
| (dmm) | | | | | | | |
| Softening | 95.6 | 120.3 | 118.8 | 129.1 | 125.2 | 124.4 | 127.0 |
| Point (° F.) | | | | | | | |
| Separation | 0 | 1.2 | 6.4 | 1.2 | 6.4 | 0.6 | 2.5 |
| (° F.) | | | | | | | |
| Viscosity #21 | 128 | 730 | 433 | 508 | 688 | 843 | 783 |
| @ 280° F. (cPs) | | | | | | | |
| Viscosity #21 | 68 | 245 | 148 | 165 | 235 | 285 | 253 |
| @ 335° F. (cPs) | | | | | | | |
| Viscosity #21 | 40 | 133 | 85 | 100 | 128 | 153 | 140 |
| @ 375° F. (cPs) | | | | | | | |

TABLE 4

| | Ex. 15 | Ex. 16 | Ex. 17 | Ex. 18 | Ex. 19 | Ex. 20 |
|---|---|---|---|---|---|---|
| AC-5 (52-22) | 96.9 | 96.9 | 96.9 | 97.9 | 98.9 | 99.4 |
| (wt %) | | | | | | |
| C-501 | 1 | 1 | 1 | 2 | 1 | 0.5 |
| (wt %) | | | | | | |
| CB1220 | 2 | 0 | 0 | 0 | 0 | 0 |
| (wt %) | | | | | | |
| CB1221 | 0 | 2 | 0 | 0 | 0 | 0 |
| (wt %) | | | | | | |
| CB1203 | 0 | 0 | 2 | 0 | 0 | 0 |
| (wt %) | | | | | | |
| S | 0.1 | 0.1 | 0.1 | 0.1 | 0.1 | 0.1 |
| (wt %) | | | | | | |
| Penetration | 111 | 110 | 109 | 109 | 115 | 109 |
| (dmm) | | | | | | |
| Separation | 2 | 3 | 5 | 2 | 2 | 1 |
| (° F.) | | | | | | |
| Viscosity #21 | 697.5 | 757.0 | 772.5 | 415.0 | 290.0 | 270.0 |
| @ 280° F. | | | | | | |
| (cPs) | | | | | | |
| Viscosity #21 | 757.0 | 250.0 | 270.0 | 142.5 | 95.0 | 105.0 |
| @ 335° F. | | | | | | |
| (cPs) | | | | | | |
| Viscosity #21 | 137.5 | 135.0 | 152.5 | 85.0 | 52.5 | 77.5 |
| @ 375° F. | | | | | | |
| (cPs) | | | | | | |

TABLE 5

| | Ex. 21 | Ex. 22 | Ex. 23 | Ex. 24 | Ex. 25 | Ex. 26 |
|---|---|---|---|---|---|---|
| AC-5 (52-22) | 98.9 | 97.9 | 96.9 | 96.9 | 96.9 | 96.9 |
| (wt %) | | | | | | |
| C-501 | 0 | 0 | 0 | 2.5 | 1.5 | 0.5 |
| (wt %) | | | | | | |
| CB24 | 1 | 2 | 3 | 0.5 | 1.5 | 2.5 |
| (wt %) | | | | | | |
| S | 0.1 | 0.1 | 0.1 | 0.1 | 0.1 | 0.1 |
| (wt %) | | | | | | |
| Penetration | 128 | 116 | 106 | 95 | 101 | 105 |
| (dmm) | | | | | | |
| Separation | 1 | 2 | 1 | 1 | 1 | 6 |
| (° F.) | | | | | | |
| Viscosity #21 | 335.0 | 645.0 | 1050.0 | 625.0 | 772.5 | 942.5 |
| @ 280° F. | | | | | | |
| (cPs) | | | | | | |
| Viscosity #21 | 115.0 | 232.5 | 372.5 | 205.0 | 245.0 | 330.0 |
| @ 335° F. | | | | | | |
| (cPs) | | | | | | |
| Viscosity #21 | 62.5 | 135.0 | 182.5 | 120.0 | 120.0 | 175.0 |
| @ 375° F. | | | | | | |
| (cPs) | | | | | | |

Tables 2-5 illustrate that polymer modification of asphalt improves penetration resistance of the asphalt material.

Table 2 illustrates that replacement of two-thirds of the SBS by homopolymeric BR but without the addition of sulfur results in modified asphalt compositions having good penetration resistance approaching that of SBS alone, but does not result in modified asphalt compositions having suitable storage stability to meet industry requirements.

Table 3 illustrates that the replacement of two-thirds of the SBS by homopolymeric BR including the addition of sulfur results in modified asphalt compositions having good penetration resistance approaching that of or as good as SBS alone, and that the storage stability is vastly improved in all compositions comprising homopolymeric BR. With the addition of sulfur, most of the samples containing homopolymeric BR had storage stabilities that meet industry requirements.

Table 3 further shows that using high cis homopolymeric BR provides comparable results in terms of storage stability and further shows higher values of penetration. With this regard, higher values of penetration may be advantageous, as whereas in warmer regions, lower penetration grades are preferred to avoid softening, higher penetration grades are used in colder regions to prevent the occurrence of excessive brittleness. High penetration grade is for example used in spray application works.

With or without the addition of sulfur, replacement of some of the SBS with another copolymeric thermoplastic elastomer did not provide a modified asphalt composition having suitable storage stability to meet industry requirements.

Table 4 (Examples 15-17) illustrates that the replacement of two-thirds of the SBS by homopolymeric high cis BR created by different Co BR catalyst systems with the addition of sulfur results in modified asphalt compositions having good penetration resistance approaching that of or as good as SBS alone, while the storage stability is also within industry requirements for Ex. 15 and Ex. 16.

Table 4 (Ex. 18-20) and Table 5 (Ex. 21-23) are further comparative examples, which illustrate that the use of lower amounts of polymer (SBS, 501 type or high cis BR, CB24) is possible with the addition of sulfur resulting in modified asphalt compositions having good penetration resistance. These materials show suitable storage stability which meet industry requirements.

Table 5 (Ex. 24-26) illustrate the effect of blends of SBS and BR with lower levels of SBS but the same total polymer loading of 3 wt % in the modified asphalt with addition of 0.1 wt % of sulfur. Lower levels of SBS can be used, however below 0.5 wt % SBS loading significant separation occurs (Ex. 26) which does not have the storage stability required to meet industry needs. Above 0.5 wt %, the materials show suitable storage stability which meet industry requirements. With the addition of sulfur, most of the samples containing homopolymeric BR had storage stabilities that meet industry requirements.

Further, modified asphalt compositions where some of the SBS is replaced by homopolymeric BR have suitably high viscosities over a range of temperatures, permitting the manufacture and shipping of concentrated modified asphalt compositions (e.g. 12-15 wt % total polymer loading) can also be envisaged. Such concentrated composition decreases production time and shipping costs. End users will be able to dilute the concentrated product as needed for particular applications.

### Testing Modified Asphalts for SHRP Asphalt Performance:

Modified asphalts were tested using standard test procedures AASHTO T313 and AASHTO T315 in a manner similar to the testing of the unmodified AC-5 (52-22 or 52-28) Asphalt described above. The testing results for the modified asphalts are provided in Tables 6-8. In Table 6, the data (Ex. 9-14) was generated based on a base bitumen of Batch 2 with a measured grading of PG 52-22. In Table 7 and Table 8, the data (Ex. 15-26) was generated based on a base bitumen of Batch 3 with a measured grading of PG 52-28.

For the asphalt grading system used in this analysis, an increase in the upper temperature range is most desirable, which is indicated by the first 2 digits of the PG grade which increase in grading every 6 degrees. So, a 1 grade increase from the base bitumen used in Ex. 9-14, would be PG 58-XX, and a 2 grade increase would be PG 64-XX. Likewise, for Ex. 15-26, a 1 grade increase would mean a PG rating of PG 58-XX and a 2 grade increase in the PG rating would be PG 64-XX.

Comparative Example 9 illustrates the effect of 3 wt % of a standard SBS commonly used in polymer modified asphalt. The addition of the polymer has increased the asphalt by 2 grades (PG 64-28) from the base asphalt (Batch 2, PG 52-22). Other examples using blends of SB polymer or BR polymer (with a constant polymer loading of 3 wt %) show either a 1 or 2 grade increases (see Table 6) demonstrating the ability of the SBS to be replaced in a blend with the presence of sulfur.

Examples using less than 3 wt % SBS (Ex. 18-20) show only a one grade increase in the upper temperature (PG 58-28) compared to the base asphalt (Batch 3, PG 52-28) using 0.1 wt % sulfur. Examples of polymer modified without the presence of SBS (Ex. 21-23) illustrate that a polymer loading of 2 wt % BR can increase the asphalt grade by 1 (Ex. 22, PG 58-28) and at 3 wt % loading can cause a 2 grade increase similar to SBS (Ex. 23, PG 64-28). Each of these compounds show suitable storage stability which meet industry requirements (see Tables 4 and 5). Table 6

| Test | Temp | Ex. 9 | Ex. 10 | Ex. 11 | Ex. 13 | Ex. 14 |
|---|---|---|---|---|---|---|
| Original Dynamic Shear (G*/sinδ, | 52° C. | 5.08 | 3.83 | 4.98 | 4.44 | 4.69 |
| 10 rad/sec) per AASHTO T315, | 58° C. | 2.52 | 1.91 | 2.58 | 2.25 | 2.37 |
| kPa | 64° C. | 1.30 | 0.99 | 1.38 | 1.18 | 1.23 |
| | 70° C. | 0.71 | N/A | 0.78 | 0.66 | 0.67 |
| Original Dynamic Shear (G*) per | 52° C. | 4.73 | 3.64 | 4.63 | 4.19 | 4.43 |
| AASHTO T315, kPa | 58° C. | 2.37 | 1.83 | 2.41 | 2.14 | 2.25 |
| | 64° C. | 1.24 | 0.95 | 1.30 | 1.13 | 1.18 |
| | 70° C. | 0.68 | N/A | 0.74 | 0.63 | 0.65 |
| Original Dynamic Shear (Phase | 52° C. | 68.63 | 71.83 | 68.50 | 70.69 | 70.65 |
| Angle °) per AASHTO T315, ° | 58° C. | 70.22 | 72.95 | 69.31 | 71.75 | 71.85 |
| | 64° C. | 71.86 | 74.12 | 70.28 | 42.98 | 73.15 |
| | 70° C. | 73.10 | N/A | 71.15 | 74.20 | 74.53 |
| Post RTFO Dynamic Shear | 52° C. | 10.60 | 8.91 | 11.80 | 9.76 | 9.82 |
| (G*/sinδ, 10 rad/sec) per | 58° C. | 5.40 | 4.50 | 6.06 | 4.90 | 4.99 |
| AASHTO T315, kPa | 64° C. | 2.83 | 2.29 | 3.13 | 2.49 | 2.57 |
| | 70° C. | 1.51 | 1.20 | 1.65 | 1.30 | 1.36 |
| Post RTFO Dynamic Shear (G*) | 52° C. | 9.53 | 8.18 | 10.60 | 8.98 | 8.97 |
| per AASHTO T315, kPa | 58° C. | 4.90 | 4.18 | 5.48 | 4.56 | 4.60 |
| | 64° C. | 2.60 | 2.16 | 2.87 | 2.34 | 2.40 |
| | 70° C. | 1.41 | 1.14 | 1.54 | 1.24 | 1.28 |
| Post RTFO Dynamic Shear | 52° C. | 64.09 | 66.65 | 63.96 | 66.94 | 65.88 |
| (Phase Angle °) per AASHTO | 58° C. | 65.18 | 68.27 | 65.00 | 68.48 | 67.22 |
| T315, ° | 64° C. | 66.57 | 70.29 | 66.61 | 70.32 | 68.96 |
| | 70° C. | 68.35 | 72.49 | 68.53 | 72.46 | 71.00 |
| Post Pressure Aging Vessel | 19° C. | 2438.26 | 1718.00 | 2464.16 | 1959.50 | 1665.55 |
| Dynamic Shear, (G*sinδ, 10 | 22° C. | 1775.55 | 1187.88 | 1899.58 | 1517.93 | 1267.58 |
| rad/sec) per AASHTO T315, kPa | 25° C. | 1324.27 | 839.6 | 1386.29 | 1119.93 | 923.40 |
| Post Pressure Aging Vessel | 19° C. | 3810.50 | 2690.64 | 3823.40 | 3038.94 | 2520.40 |
| Dynamic Shear, (G*) per | 22° C. | 2663.43 | 1756.69 | 2881.39 | 2292.82 | 1872.27 |
| AASHTO T315, kPa | 25° C. | 1932.90 | 1199.52 | 2004.92 | 1642.96 | 1327.20 |
| Post Pressure Aging Vessel | 19° C. | 39.78 | 39.67 | 40.13 | 40.15 | 41.36 |
| Dynamic Shear, (Phase Angle °) | 22° C. | 41.81 | 42.55 | 41.24 | 41.46 | 42.61 |
| per AASHTO T315, ° | 25° C. | 43.25 | 44.42 | 42.68 | 42.97 | 44.09 |
| Creep Stiffness, Stiffness @ 60 | −12° C. | 58.8 | 42.5 | 53.2 | 46.4 | 44.7 |
| sec, per AASHTO T313, MPa | −18° C. | 128 | 81 | 87.1 | 109 | 101 |
| | −24° C. | 273 | N/A | N/A | N/A | 210 |
| Creep Stiffness, m-value @ 60 | −12° C. | 0.345 | 0.362 | 0.327 | 0.355 | 0.356 |
| sec per AASHTO T313 | −18° C. | 0.314 | 0.318 | 0.290 | 0.323 | 0.319 |
| | −24° C. | 0.284 | N/A | N/A | N/A | 0.295 |
| PG | | 64-28 | 58-28 | 64-22 | 64-28 | 64-28 |

TABLE 7

| Test | Temp | Ex 15 | Ex. 16 | Ex. 17 | Ex. 18 | Ex. 19 | Ex. 20 |
|---|---|---|---|---|---|---|---|
| Original Dynamic Shear | 52° C. | 3.687 | 4.691 | 4.574 | 3.318 | x | 2.426 |
| (G*/sinδ, 10 rad/sec) per | 58° C. | 1.858 | 2.343 | 2.305 | 1.564 | 1.121 | 1.029 |
| AASHTO T315, kPa | 64° C. | 0.980 | 1.232 | 1.310 | 0.779 | 0.529 | 0.473 |
| | 70° C. | x | 0.686 | 0.833 | x | x | x |
| Original Dynamic Shear | 52° C. | 3.466 | 4.372 | 4.339 | 3.179 | x | 2.403 |
| (G*) per AASHTO T315, | 58° C. | 1.760 | 2.204 | 2.206 | 1.510 | 1.108 | 1.023 |
| kPa | 64° C. | 0.936 | 1.168 | 1.265 | 0.757 | 0.525 | 0.471 |
| | 70° C. | x | 0.655 | 0.811 | x | x | X |
| Original Dynamic Shear | 52° C. | 70.08 | 68.75 | 71.53 | 73.38 | x | 82.00 |
| (Phase Angle °) per | 58° C. | 71.37 | 70.13 | 73.08 | 74.95 | 81.12 | 83.95 |
| AASHTO T315, ° | 64° C. | 72.72 | 71.47 | 74.97 | 76.48 | 82.92 | 85.50 |
| | 70° C. | x | 72.82 | 76.87 | x | x | X |
| Post RTFO Dynamic Shear | 52° C. | x | x | x | x | x | X |
| (G*/sinδ, 10 rad/sec) per | 58° C. | 3.798 | 4.176 | 4.196 | 3.614 | 3.978 | 2.607 |
| AASHTO T315, kPa | 64° C. | 1.965 | 2.132 | 2.134 | 1.772 | 2.122 | 1.147 |
| | 70° C. | x | x | x | x | x | X |
| Post RTFO Dynamic Shear | 52° C. | x | x | x | x | x | X |
| (G*) per AASHTO T315, | 58° C. | 3.503 | 3.843 | 3.880 | 3.388 | 3.843 | 2.555 |
| kPa | 64° C. | 1.838 | 1.991 | 2.002 | 1.681 | 2.07 | 1.133 |
| | 70° C. | x | x | x | x | x | X |
| Post RTFO Dynamic Shear | 52° C. | x | x | x | x | x | x |
| (Phase Angle °) per | 58° C. | 67.28 | 66.95 | 67.60 | 69.60 | 75.06 | 78.58 |
| AASHTO T315, ° | 64° C. | 69.31 | 69.02 | 69.67 | 71.61 | 77.31 | 81.00 |
| | 70° C. | x | x | x | x | x | x |
| Post Pressure Aging | 19° C. | 1,979 | x | 1,923 | x | x | x |
| Vessel Dynamic Shear, | 16° C. | 2,688 | x | 2,589 | x | x | x |
| (G*sinδ, 10 rad/sec) per | 13° C. | 3,594 | 3,060 | 3,425 | 4,783 | 4,863 | 4,650 |
| AASHTO T315, kPa | 10° C. | 4,743 | 4,066 | 4,481 | 6,215 | 6,326 | 6,097 |
| | 7° C. | 6,207 | 5,303 | 5,808 | x | x | x |
| Post Pressure Aging | 19° C. | 3,190 | x | 3,219 | x | x | x |
| Vessel Dynamic Shear, (G*) | 16° C. | 4,517 | x | 4,514 | x | x | x |
| per AASHTO T315, kPa | 13° C. | 6,296 | 5,454 | 6,207 | 9,097 | 9,375 | 8,679 |
| | 10° C. | 8,661 | 7,558 | 8,433 | 12,313 | 12,751 | 11,877 |
| | 7° C. | 11,812 | 10,252 | 11,343 | x | x | x |
| Post Pressure Aging | 19° C. | 38.33 | x | 36.68 | x | x | x |
| Vessel Dynamic Shear, | 16° C. | 36.51 | x | 35.00 | x | x | x |
| (Phase Angle °) per | 13° C. | 34.81 | 34.13 | 33.49 | 31.72 | 31.24 | 32.39 |
| AASHTO T315, ° | 10° C. | 33.20 | 32.55 | 32.10 | 30.32 | 29.74 | 30.89 |
| | 7° C. | 31.70 | 31.15 | 30.80 | x | x | x |
| Creep Stiffness, @ 60 sec, | −12° C. | 36.3 | 30.5 | 34.9 | 52.1 | 52.2 | 56.5 |
| per AASHTO T313, MPa | −18° C. | 89.6 | 80.9 | 77.2 | 111 | 109 | 114 |
| Creep Stiffness, m-value @ | −12° C. | 0.351 | 0.379 | 0.371 | 0.342 | 0.341 | 0.335 |
| 60 sec per AASHTO T313 | −18° C. | 0.309 | 0.337 | 0.321 | 0.304 | 0.308 | 0.302 |
| PG | | 58-28 | 58-28 | 58-28 | 58-28 | 58-28 | 58-28 |

TABLE 8

| Test | Temp | Ex 21 | Ex. 22 | Ex. 23 | Ex. 24 | Ex. 25 | Ex. 26 |
|---|---|---|---|---|---|---|---|
| Original Dynamic Shear | 52° C. | 1.895 | x | x | x | x | x |
| (G*/sinδ, 10 rad/sec) per | 58° C. | 0.959 | 1.184 | 1.983 | 1.969 | 1.772 | 1.940 |
| AASHTO T315, kPa | 64° C. | x | 0.63 | 1.058 | 1.075 | 0.929 | 1.032 |
| | 70° C. | x | x | 0.600 | 0.624 | x | 0.582 |
| Original Dynamic Shear | 52° C. | 1.858 | x | x | x | x | x |
| (G*) per AASHTO T315, | 58° C. | 0.945 | 1.142 | 1.887 | 1.844 | 1.683 | 1.840 |
| kPa | 64° C. | x | 0.612 | 1.015 | 1.011 | 0.889 | 0.986 |
| | 70° C. | x | x | 0.579 | 0.587 | x | 0.560 |
| Original Dynamic Shear | 52° C. | 78.65 | x | x | x | x | x |
| (Phase Angle °) per | 58° C. | 80.15 | 74.79 | 72.14 | 69.44 | 71.74 | 71.52 |
| AASHTO T315, ° | 64° C. | x | 76.18 | 73.50 | 70.09 | 73.17 | 72.92 |
| | 70° C. | x | x | 74.96 | 70.17 | x | 74.44 |
| Post RTFO Dynamic Shear | 52° C. | x | x | x | x | x | x |
| (G*/sinδ, 10 rad/sec) per | 58° C. | 2.735 | 2.701 | 4.577 | 4.450 | 4.314 | 4.274 |
| AASHTO T315, kPa | 64° C. | 1.292 | 1.362 | 2.38 | 2.370 | 2.249 | 2.194 |
| | 70° C. | x | x | 1.255 | 1.297 | 1.203 | x |
| Post RTFO Dynamic Shear | 52° C. | x | x | x | x | x | x |
| (G*) per AASHTO T315, | 58° C. | 2.633 | 2.561 | 4.280 | 4.024 | 3.956 | 3.964 |
| kPa | 64° C. | 1.255 | 1.305 | 2.256 | 2.170 | 2.091 | 2.63 |
| | 70° C. | x | x | 1.205 | 1.204 | 1.136 | x |
| Post RTFO Dynamic Shear | 52° C. | x | x | x | x | x | x |
| (Phase Angle °) per | 58° C. | 74.30 | 71.48 | 69.24 | 64.74 | 66.48 | 68.03 |
| AASHTO T315, ° | 64° C. | 76.36 | 73.38 | 71.44 | 66.27 | 68.39 | 70.14 |
| | 70° C. | x | x | 73.81 | 68.21 | 70.73 | x |
| Post Pressure Aging | 19° C. | x | x | x | x | x | x |
| Vessel Dynamic Shear, | 16° C. | x | x | x | x | x | x |
| (G*sinδ, 10 rad/sec) per | 13° C. | 3,189 | 4,247 | x | 4,030 | 3,781 | 3,524 |
| AASHTO T315, kPa | 10° C. | 4,157 | 5,273 | 3,944 | 5,031 | 4,962 | 4,571 |
| | 7° C. | 5,365 | x | 5,132 | x | 6,424 | 5,883 |
| Post Pressure Aging | 19° C. | x | x | x | x | x | x |
| Vessel Dynamic Shear, (G*) | 16° C. | x | x | x | x | x | x |
| per AASHTO T315, kPa | 13° C. | 5,925 | 7,810 | x | 7,373 | 6,902 | 6,515 |
| | 10° C. | 8,006 | 9,993 | 7,354 | 9,493 | 9,446 | 8,710 |
| | 7° C. | 10,731 | x | 9,940 | x | 12,720 | 11,630 |
| Post Pressure Aging | 19° C. | x | x | x | x | x | x |
| Vessel Dynamic Shear, | 16° C. | x | X | x | x | x | x |
| (Phase Angle °) per | 13° C. | 32.56 | 32.94 | x | 33.13 | 33.21 | 32.75 |
| AASHTO T315, ° | 10° C. | 31.28 | 31.85 | 32.43 | 32.00 | 31.69 | 31.66 |
| | 7° C. | 30.00 | x | 31.08 | x | 30.33 | 30.39 |
| Creep Stiffness, @ 60 sec, | −12° C. | 60.5 | 41.6 | 34.6 | 48.0 | 39.7 | 35.3 |
| per AASHTO T313, MPa | −18° C. | 121 | 96.6 | 66.2 | 90.8 | 82.1 | 60.9 |
| Creep Stiffness, m-value @ | −12° C. | 0.325 | 0.344 | 0.349 | 0.339 | 0.350 | 0.366 |
| 60 sec per AASHTO T313 | −18° C. | 0.289 | 0.320 | 0.328 | 0.306 | 0.324 | 0.329 |
| PG | | 52-22 | 58-28 | 64-28 | 64-28 | 58-28 | 64-28 |

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A modified asphalt composition comprising:
a bituminous component;
a copolymeric thermoplastic elastomer;
a high-cis homopolymeric polybutadiene rubber; and,
a cross-linking agent,
wherein the high-cis homopolymeric polybutadiene rubber has a cis content of >93%.

2. (canceled)

3. The composition according to claim 1, wherein the high-cis homopolymeric polybutadiene rubber and the copolymeric thermoplastic elastomer are present in a weight ratio of high-cis homopolymeric polybutadiene rubber to copolymeric thermoplastic elastomer of about 5:1 to about 1:1.

4. The composition according to claim 1, wherein the high-cis homopolymeric polybutadiene rubber has a Mooney viscosity of about 41 (ML 1+4 @ 100° C.) or greater.

5. The composition according to claim 1, wherein the high-cis homopolymeric polybutadiene rubber has a Mooney viscosity in a range of about 44-70 (ML 1+4 @ 100° C.).

6. The composition according to claim 1, wherein the high-cis homopolymeric polybutadiene rubber is a neodymium grade homopolymeric polybutadiene rubber.

7. The composition according to claim 1, wherein the high-cis homopolymeric polybutadiene rubber is present in a range of about 1-3 wt %, based on total weight of the modified asphalt composition.

8. The composition according to claim 1, wherein the copolymeric thermoplastic elastomer is present in a range of about 1-3 wt %, based on total weight of the modified asphalt composition.

9. The composition according to claim 1, wherein the copolymeric thermoplastic elastomer comprises styrene-butadiene-styrene (SBS).

10. The composition according to claim 91, wherein the copolymeric thermoplastic elastomer comprises styrene-butadiene-styrene and wherein the styrene-butadiene-styrene has a styrene content in a range of about 20-55%, based on total weight of the styrene-butadiene-styrene.

11. The composition according to claim 1, wherein the cross-linking agent is present in a range of about 0.05-1 wt %, based on total weight of the modified asphalt composition.

12. The composition according to claim 1, wherein the cross-linking agent is elemental sulfur.

13. The composition according to claim 1, wherein the bituminous component comprises bitumen.

14. A process for producing a modified asphalt composition comprising
mixing a mixture of a copolymeric thermoplastic elastomer, a high-cis homopolymeric polybutadiene rubber, a cross-linking agent and a bituminous component to form the modified asphalt composition.

15. The process according to claim 14, comprising
mixing a mixture of a copolymeric thermoplastic elastomer, a high-cis homopolymeric polybutadiene rubber, and a cross-linking agent with a bituminous component to form the modified asphalt composition.

16. A method comprising applying an asphalt composition to a surface, wherein the asphalt composition is a composition according to claim 1.

17. The method according to claim 16, wherein the surface is a road undergoing construction or repair, at least one substance to be adhesively bonded, a surface to be waterproofed, a surface to be weatherproofed, or a roof.
